(19) United States
(12) Patent Application Publication
(10) Pub. No.: US 2009/0174620 A1
(43) Pub. Date: Jul. 9, 2009

(54) Phased array antenna having the highest efficiency at slant angle

(76) Inventors: Young-Sik Kim, Incheon (KR); Sang-Won Lee, Seoul (KR); Yong-Ki Lee, Seoul (KR)

Correspondence Address: Law Office of ROBERT C. KLINGER, 2591 Dallas Parkway, Suite 300, FRISCO, TX, 75034, US

(21) Appl. No.: 11/921,411

(22) PCT Filed: Jun. 7, 2006
(86) PCT No.: PCT/KR2006/002177

§ 371 Date: Nov. 30, 2007

(30) Foreign Application Priority Data
Jun. 7, 2005 (KR) 10-2005-0048578

(51) Int. Cl. H01Q 21/29; H01Q 1/36; H01Q 1/42

(52) U.S. Cl. 343/872; 343/895; 343/893

(57) ABSTRACT

The present invention relates to a phased array antenna, which is configured such that a plurality of radiation elements, having high reception efficiency for radio waves incident at a tilt angle, is arranged in a plurality of rows and columns, thus attaining high reception efficiency, and which adjusts radio waves, incident through a radome for protecting the antenna, to a desired tilt angle, thus further increasing radio wave reception efficiency.

For this purpose, the present invention includes a printed circuit board provided with a plurality of electrical and electronic devices for processing radio waves received from a satellite; and a plurality of radiation elements arranged and mounted on the printed circuit board in a plurality of rows and columns, formed such that the radiation characteristic for the received radio waves is maximized at the tilt angle, and formed in a helical or monopolar form to be optimized for the radio waves received at the tilt angle. Furthermore, the present invention is configured such that a radome through which the radio waves pass is installed outside the printed circuit board on which the radiation elements are mounted, wherein, in order to allow radio waves, passing through and refracted, to be converged at the tilt angle at which the reception efficiency of the radiation elements is maximized, an uneven surface is formed on the inner or outer surface of the radome. Furthermore, in order to allow the radio waves, passing through and refracted, to be maintained at the tilt angle at which the reception efficiency of the radiation elements is maximized, the radome includes a sidewall member provided on the sides of the printed circuit board, and a cover member configured to be connected to the upper portions of the sidewall member and to be lifted and lowered upward and downward from the sidewall member, wherein a lifting drive unit for selectively lifting and lowering the cover member is installed on the sidewall member and the cover unit.

### TECHNICAL FIELD

The present invention relates to a phased array antenna having maximum reception efficiency at a tilt angle and, more particularly, to a phased array antenna, which is configured such that a plurality of radiation elements, having high reception efficiency for radio waves incident at a tilt angle, is arranged in a plurality of rows and columns, thus attaining high reception efficiency, and which adjusts radio waves, incident through a radome for protecting the antenna, to a desired tilt angle, thus further increasing radio wave reception efficiency.

### BACKGROUND ART

A phased array antenna is a planar type of device that is constructed by arranging a plurality of radiation elements on a board, thus realizing increased radio wave reception efficiency.

FIG. 1 shows a patch-type radiation element, which is chiefly applied to a phased array antenna, and FIG. 2 is a graph showing the radiation characteristic and the reception efficiency of the radiation element of FIG. 1.

With reference to the drawings, the patch-type radiation element 1 is disposed on a board 2 to thus receive most radio waves, and a radiation region, which is approximately circular, is formed on the radiation element. For the circular radiation region, it can be seen that the radiation characteristic is maximized along a vertical line. Further it can be seen that the radiation characteristic with respect to radio waves incident at an angle decreases in proportion to the decrease in angle.

In a conventional phased array antenna, implemented using the radiation element 1 described above, a plurality of radiation elements 1 is arranged and installed in a plurality of rows and columns on a printed circuit board 2, on which various electrical and electronic devices are mounted, as shown in FIG. 3.

That is, the phased array antenna is constructed so as to maximize the reception efficiency of radio waves for an antenna having a predetermined size using the plurality of radiation elements 1. With reference to the radiation characteristic graph of FIG. 4, a characteristic in which the reception rate for radio waves received by the plurality of radiation elements 1 is maximized at an angle corresponding to a vertical line and decreases considerably at a tilt angle is exhibited.

The above-described phased array antenna has recently been the most popular type of antenna for receiving radio waves for use as an antenna for receiving electronic-type beam steering radar or satellite broadcasts.

When applied to an actual product, as shown in FIGS. 5 and 6, the conventional phased array antenna having the above-described characteristic is typically installed on top of an automobile 3, collects radio waves, and transmits the collected radio waves to a device, such as a satellite broadcasting receiver, which is provided in the automobile 3.

In FIG. 5, the printed circuit board 2 on which the radiation elements 1 are arranged is mounted in a tilted position on top of the automobile 3, and is constructed to be rotated by a drive means 4 including a motor and a belt drive mechanism. A radome 5, through which radio waves pass, is installed outside the printed circuit board 2 in order to protect electronic wave reception equipment including the radiation element 1 and the printed circuit board 2.

In the phased array antenna, the tilt of the printed circuit board 2 must be adjusted such that the radio wave reception angle of the phased array antenna can be maintained at about 45° from the earth's surface in order to receive electronic waves, which are transmitted from a satellite in stationary orbit, at maximum efficiency.

Accordingly, the orientation of the printed circuit board is configured to maintain such an angle, and thus the drive means 4 is required to provide optimal directionality for the reception of radio waves in response to change in the location of the automobile 3.

As another example, in FIG. 6, the printed circuit board 2 is installed in a direction parallel to the earth's surface, so that the height of the installation is less than that of the example of FIG. 5.

### DISCLOSURE

### Technical Problem

The conventional phased array antenna described above is disadvantageous in that reception efficiency for phase transmission radio waves, the maximum reception efficiency of which can be expected at an angle of 45°, is low because the radiation elements each have the maximum radio wave reception efficiency in a vertical direction.

Accordingly, in the case where the phased array antenna is applied to satellite reception antennas for automobiles, the printed circuit board on which the radiation elements are arranged is installed at a tilt angle with respect to the earth's surface, thus increasing the total height of the antenna.

Furthermore, in the case where the printed circuit board is installed parallel to the earth's surface in order to prevent an increase in height, the radio wave reception efficiency is low. In order to overcome this problem, an increase in the number of installed radiation elements (more than four times per unit area) and an increase in the area of the printed circuit board are inevitable.

Accordingly, in the case where a large-sized phased array antenna such as that described above is exposed to the outside, the aesthetics of the automobile suffer. In the case where the antenna is provided inside the automobile in order to overcome this problem, problems occur in that the space inside the automobile is decreased because the ceiling thereof is somewhat lowered and, at the same time, there is difficulty in designing the antenna because the installation location of the antenna must be determined in consideration of various components installed on the automobile antenna.

### Technical Solution

The present invention has been made keeping in mind the above problems occurring in the prior art, and an object of the present invention is to provide a phased array antenna, which is configured such that a plurality of radiation elements, having the maximum receiving rate for radio waves received at a tilt angle, is arranged in a plurality of rows and columns, thus mitigating the increases in height and planar area caused by the tilted installation of the antenna, and from which a drive means for setting the direction of the antenna can be omitted.

Another object of the present invention is to provide a phased array antenna that is capable of maintaining an optimal angle for radio waves when the radio waves, which pass through a radome and are refracted, are received through the antenna.

### Advantageous Effects

The antenna is implemented using radiation elements having maximum reception efficiency for radio waves received at a tilt angle, and the increased height and planar area caused by the slant installation of the antenna can be mitigated, so that a compact antenna can be realized, therefore the space required for installation of the antenna is reduced and the efficiency thereof can be improved.

Furthermore, the present invention has no connection with the directionality of the reception of radio waves, so that a drive means for changing the direction of the antenna is not required, therefore the cost of manufacturing the antenna is considerably reduced, and the manufacturing process is convenient.

Furthermore, the height of the radome, through which the radio waves are refracted and pass, and the internal structure thereof are implemented so as to optimize the reception angle of radio waves incident on the radiation elements, so that improved radio wave reception efficiency can be attained, therefore the present invention contributes to the realization of high-quality products.

### DESCRIPTION OF DRAWINGS

FIG. 1 is a perspective view of a typical patch-type antenna;

FIG. 2 is a graph showing the radiation characteristic of the patch-type antenna of FIG. 1;

FIG. 3 is a perspective view showing the construction of a conventional phased array antenna;

FIG. 4 is a graph of the radiation characteristic of the conventional phased array antenna;

FIG. 5 is a diagram showing an example of use of the phased array antenna of FIG. 3;

FIG. 6 is a diagram showing another example of use of the phased array antenna of FIG. 3;

FIG. 7 is a perspective view showing a radiation element applied to the present invention;

FIG. 8 is a graph showing the radiation characteristic of the radiation element of FIG. 7;

FIG. 9 is a perspective view showing the construction of a phased array antenna according to the present invention;

FIG. 10 is a graph showing the radiation characteristic of the phased array antenna according to the present invention;

FIG. 11 is a diagram showing an example in which the phased array antennal according to the present invention is used; and

FIG. 12 is a sectional view of an additional embodiment of the present invention.

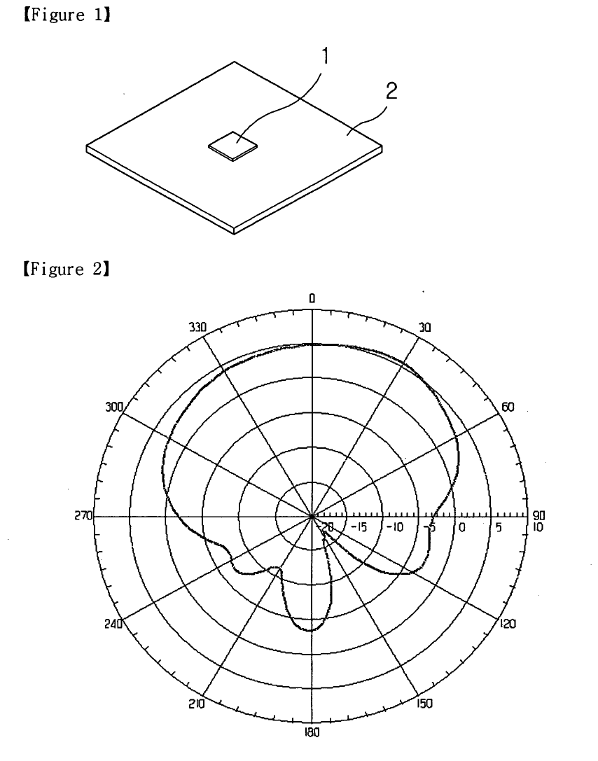

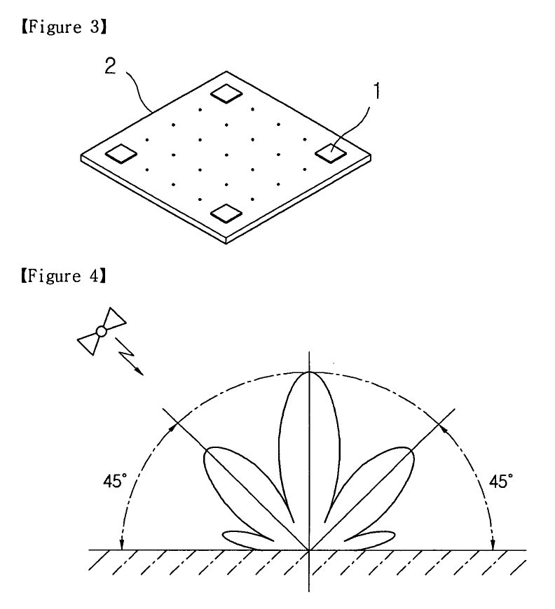

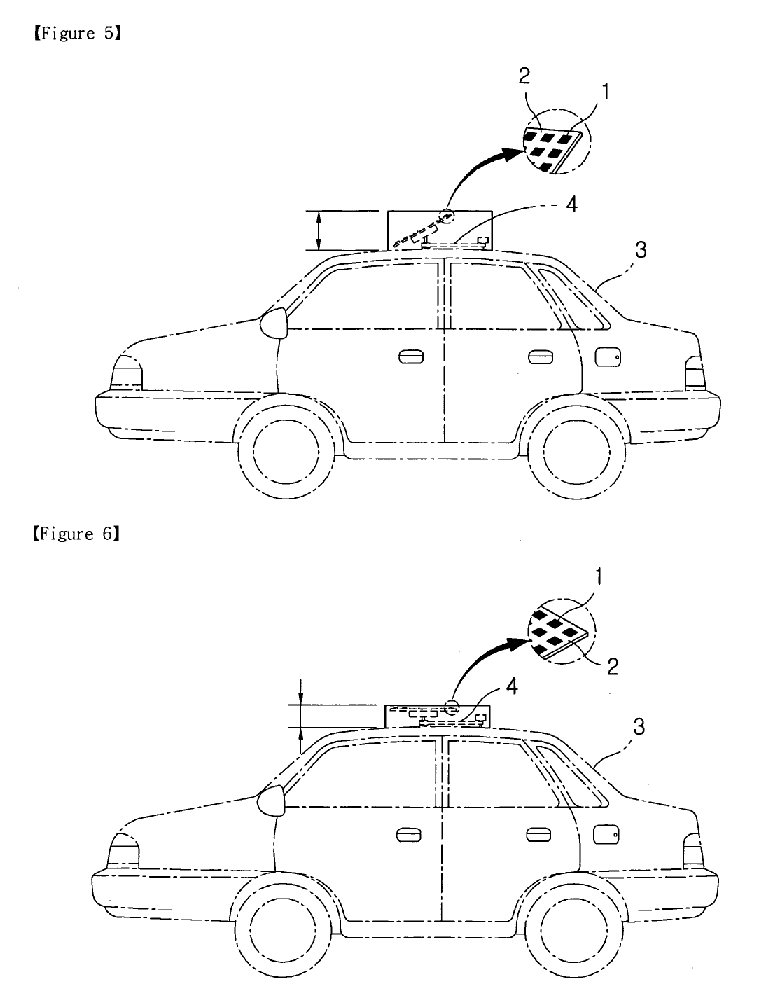

### BEST MODE

In order to accomplish the above objects, the present invention is characterized as follows:

The present invention includes a printed circuit board provided with a plurality of electrical and electronic devices for processing radio waves received from a satellite; and a plurality of radiation elements arranged and mounted on the printed circuit board in a plurality of rows and columns, formed such that the radiation characteristic for the received radio waves is maximized at the tilt angle, and formed in a helical or monopolar form to be optimized for the radio waves received at the tilt angle.

In order to accomplish another object, the present invention is configured such that a radome through which the radio waves pass is installed outside the printed circuit board on which the radiation elements are mounted, wherein, in order to allow radio waves, passing through and refracted, to be converged at the tilt angle at which the reception efficiency of the radiation elements is maximized, an uneven surface is formed on the inner or outer surface of the radome.

Furthermore, in order to allow the radio waves, passing through and refracted, to be maintained at the tilt angle at which the reception efficiency of the radiation elements is maximized, the radome includes a sidewall member provided on the sides of the printed circuit board, and a cover member configured to be connected to the upper portions of the sidewall member and to be lifted and lowered upward and downward from the sidewall member, wherein a lifting drive unit for selectively lifting and lowering the cover member is installed on the sidewall member and the cover unit.

An embodiment of the present invention, to which the above-described construction is applied, is described in detail with reference to the accompanying drawings below.

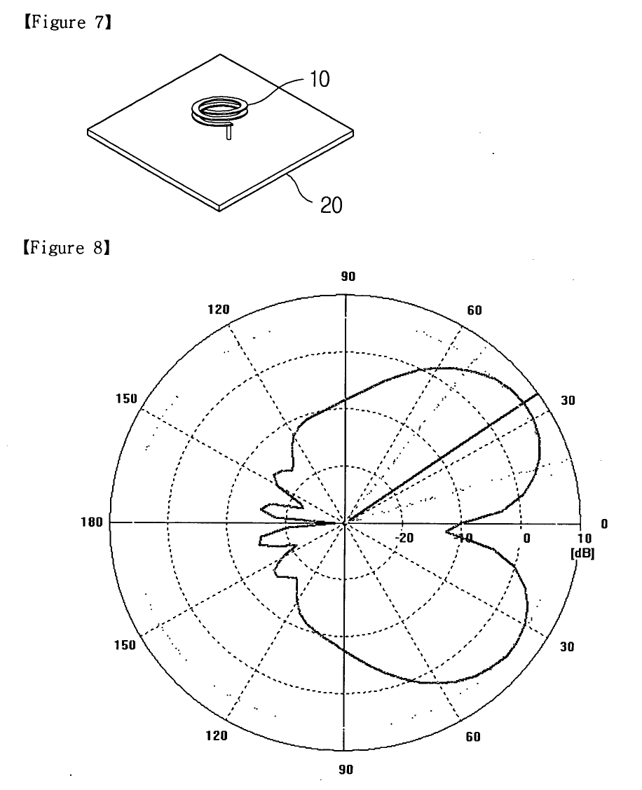

FIG. 7 is a perspective view showing a radiation element applied to the present invention, and FIG. 8 is a graph showing the radiation characteristic of the radiation element of FIG. 7.

With reference to the drawings, the radiation element 10 is a helical-type antenna. It can be seen that the helical-type radiation element 10 has the maximum radiation characteristic for radio waves received at an angle of about 45°.

In particular, the radiation element 10 has a structure in which a plate-type flat member is wound in a helical form. If a simpler manufacturing scheme is required, a radiation element having a structure in which a core member having a circular section is formed in a helical form may be used.

Furthermore, of the radiation elements 10, a dipole-type radiation element, having a structure in which a single core member is erected, also has high reception efficiency at a tilt angle even though it has somewhat varying reception efficiency for radio waves incident at a tilt angle.

Accordingly, as the radiation elements, helical-type radiation elements, each having a flat or circular section, and dipole-type radiation elements may be selectively used.

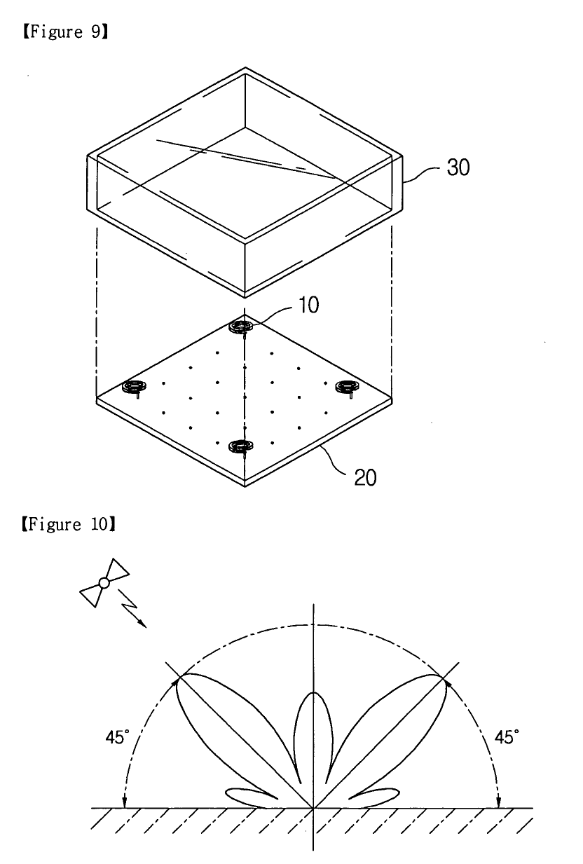

FIG. 9 is a perspective view showing the construction of a phased array antenna according to the present invention, and FIG. 10 is a graph showing the radiation characteristic of the phased array antenna according to the present invention.

With reference to the drawings, the phased array antenna according to the present invention is constructed such that the radiation elements 10 are mounted on a printed circuit board 20, and a radome 30 is installed outside the printed circuit board 20.

The printed circuit board 20 is constructed such that a plurality of electrical and electronic devices for processing radio waves received from a satellite is mounted thereon.

The radiation elements 10 are arranged and mounted on the printed circuit board 20 in a plurality of rows and columns, and are constructed using radiation elements having a structure in which a radiation characteristic for the received radio waves is maximized at a tilt angle and, therefore, optimized for reception of radio waves received at a tilt angle.

In this case, the radiation elements 10, as described above, may be helical-type radiation elements (including both flat and circular radiation elements) or monopole-type radiation elements, and the two types of radiation elements may be used in combination according to the case.

The phased array antenna constructed as described above exhibits maximum efficiency for radio waves incident at a tilt angle of about 45°.

For reference, when a broadcasting satellite is located above the equator at an altitude of about 36,000 km, the rotational velocity thereof is the same as that of the earth, and the satellite seems to be stationary above the earth. In this case, the average angle formed between the viewing locations of most subscribers, receiving signals from the satellite located in stationary obit, and the broadcasting satellite is about 45°.

That is, the phased array antenna constructed as described above can attain maximum reception efficiency for satellite radio waves while being positioned parallel to the earth's surface regardless of specific directionality.

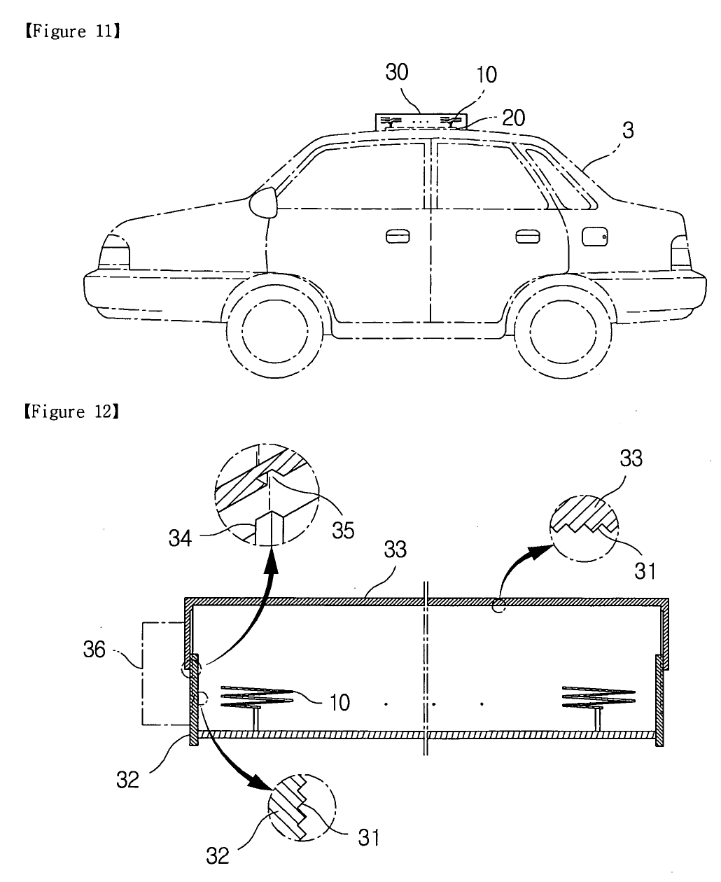

When the phased array antenna, as shown in FIG. 11, is installed on top of the automobile 3 according to the above-described technical scheme, the maximum reception efficiency is attained regardless of the directionality of the antenna even through the antenna is installed parallel to the earth's surface, so that reception of digital satellite broadcasting can be optimized.

The radome 30 is a casing that is installed around the antenna and is constructed to form the exterior in order to protect the printed circuit board 20 and the radiation element 10, constituting the antenna, from external impact, foreign substances and the like. In this case, the radome 30 must be formed of a material that allows radio waves to pass therethrough.

### Additional Embodiment

FIG. 12 is a sectional view of an additional embodiment of the present invention.

With reference to the drawing, the phased array antenna of the additional embodiment proposes a structure in which most of the radio waves that are refracted and pass through the radome 30 converge or are maintained at an angle of 45°, that is, the angle at which the maximum reception efficiency of the radiation elements 10 is attained.

In order to converge the radio waves at a tilt angle of about 45°, an uneven surface 31 is formed on the inner or outer surface of the radome 30.

The uneven surface 31 is formed over some portions or the entire surface, so that radio waves incident at an angle of about 45° can maximally converge.

In this case, although the uneven surface 31 is illustrated as having the simplest triangular shape, an uneven surface having either a concave lens shape or a convex lens shape may be used selectively or in combination, and the present invention is not limited to the described shape.

Furthermore, in order to maintain a maximum amount of radio waves at a tilt angle of about 45°, the radome 30 includes a sidewall member 32 provided on the sides of the printed circuit board 20, and a cover member 33 configured to be connected to the upper portions of the sidewall member 32 and ascend and descend upward and downward from the sidewall member 32.

In this case, the cover member 33 and the sidewall member 32 have a structure in which a guide projection 34 and a guide groove 35 are formed on the opposite surfaces of the cover member 33 and the sidewall member 32 to guide a lifting rail.

Furthermore, it is preferred that a lifting drive unit 36 for lifting and lowering the cover member 33 be selectively installed on the sidewall member 32 and the cover member 33, and that automatic lifting and lowering of the cover member 33 be implemented. In this case, the lifting drive unit 36 may be provided with a cylinder for performing only rectilinear motion, or a device for performing rectilinear motion using a motor and a linking mechanism, even though this is complicated.

1. A phased array antenna having maximum efficiency at a tilt angle, comprising: a printed circuit board provided with a plurality of electrical and electronic devices for processing radio waves received from a satellite; a plurality of radiation elements arranged and mounted on the printed circuit board in a plurality of rows and columns, formed such that a radiation characteristic for the received radio waves is maximized at the tilt angle, and formed in a helical or monopolar form to be optimized for the radio waves received at the tilt angle.

2. The phased array antenna according to claim 1, wherein a radome through which the radio waves pass is installed outside the printed circuit board on which the radiation elements are mounted, wherein, in order to allow radio waves, passing through and refracted, to be converged at the tilt angle at which reception efficiency of the radiation elements is maximized, an uneven surface is formed on an inner or outer surface of the radome.

3. The phased array antenna according to claim 1, wherein a radome through which the radio waves pass is installed outside the printed circuit board on which the radiation elements are mounted, wherein, in order to allow the radio waves, passing through and refracted, to be maintained at the tilt angle at which reception efficiency of the radiation elements is maximized, the radome comprises a sidewall member provided on sides of the printed circuit board, and a cover member configured to be connected to upper portions of the sidewall member and to be lifted and lowered upward and downward from the sidewall member, wherein a lifting drive unit for selectively lifting and lowering the cover member is installed on the sidewall member and the cover unit.

4. The phased array antenna according to claim 2, wherein a radome through which the radio waves pass is installed outside the printed circuit board on which the radiation elements are mounted, wherein, in order to allow the radio waves, passing through and refracted, to be maintained at the tilt angle at which reception efficiency of the radiation elements is maximized, the radome comprises a sidewall member provided on sides of the printed circuit board, and a cover member configured to be connected to upper portions of the sidewall member and to be lifted and lowered upward and downward from the sidewall member, wherein a lifting drive unit for selectively lifting and lowering the cover member is installed on the sidewall member and the cover unit.
